(19) United States
(12) Patent Application Publication
(10) Pub. No.: US 2004/0115993 A1
(43) Pub. Date: Jun. 17, 2004

(54) Electrical connector with improved contacts

(76) Inventor: Chin-Te Lai, Tu-chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/407,706

(22) Filed: Apr. 3, 2003

(30) Foreign Application Priority Data
Dec. 13, 2002 (TW) 91220218

(51) Int. Cl. H01R 24/00

(52) U.S. Cl. 439/660

(57) ABSTRACT

An electrical connector (1) has an insulative housing (10), a shielding member (12) and a number of terminals (13) received in the insulative housing. The insulative housing includes a base plate (101), a mating board (102) extending upwardly from the base plate and a pair of side portions (106) formed at opposite lateral ends of the base plate. The mating board has a number of passageways (100) defined symmetrically at opposite sides thereof. A pair of tapered portions (109) extend into a corresponding passageway. Each terminal has a mating section (130), a fixing section (131) extending from the mating section, a bending section (132) and a soldering section (133) extending from the bending section. The mating section has a pair of depressed portions (134) engaging with the tapered portions to reliably retain the mating section in the passageway.

### CROSS-REFERENCE TO RELATED APPLICATION

The present application is related to a commonly assigned U.S. patent application Ser. No. 10/302,060, filed on Nov. 21, 2002, entitled “ELECTRICAL CONNECTOR HAVING IMPROVED SHIELDING MEMBER AND METHOD OF MAKING THE SAME”, and which is hereby fully incorporated by reference.

### BACKGROUND OF THE INVENTION

1. Field of the Invention

The present invention relates to an electrical connector, and particularly to an electrical connector with improved contacts.

2. Description of Related Art

U.S. Pat. No. 6,435,912 issued to Zhu et al. on Aug. 20, 2002 discloses an electrical connector. The electrical connector has a mating cavity opening to a mating face and a mating rib projecting, centrally of the mating cavity, from a base wall of the connector. The mating rib defines a plurality of passageways for receiving corresponding conductive contacts, wherein portions of the contacts are exposed to the mating cavity. Each contact has a fixing portion and a mating portion. The fixing portion is fixed in the passageway. The mating rib has protrusions projecting from a front end thereof rearwardly into the passageways for engaging with recesses defined in a front end of each contact thereby securing the contacts to the mating rib. In such a way, the contacts are reliably retained in the housing. However, some connectors have passageways extending through the whole mating rib thereof and can not be provided with protrusions at a front end of the mating rib thereof, so contacts thereof cannot be retained in the above mentioned way.

Hence, it is desirable to provide an electrical connector with improved contacts.

### SUMMARY OF THE INVENTION

Accordingly, an object of the present invention is to provide an electrical connector having improved contacts firmly received in an insulative housing thereof.

In order to achieve the above-mentioned object, an electrical connector has an insulative housing, a shielding member assembled to the insulative housing and a plurality of terminals received in the insulative housing. The insulative housing includes a base plate, a mating board extending upwardly from the base plate and a pair of side portions formed at opposite lateral ends of the base plate. The mating board has a plurality of passageways defined symmetrically at opposite sides thereof and a pair of tapered portions extending from opposite inner walls of each passageway toward each other and into corresponding passageway. Each terminal has a mating section, a fixing section extending from the mating section, a bending section bending perpendicularly to the fixing section and a soldering section extending from the bending section and substantially parallel to the mating section. The mating section has a pair of depressed portions recessed from opposite sides adjacent to a top end thereof for engaging with the tapered portions to be firmly received in the passageway.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an electrical connector in accordance with the present invention;

FIG. 2 is an exploded view of the electrical connector of FIG. 1;

FIG. 3 is a partly enlarged view taken from FIG. 2;

FIG. 4 is a front view of FIG. 3; and

FIG. 5 is an enlarged view of a terminal shown in FIG. 1.

### DETAILED DESCRIPTION OF PREFERRED EMBODIMENT

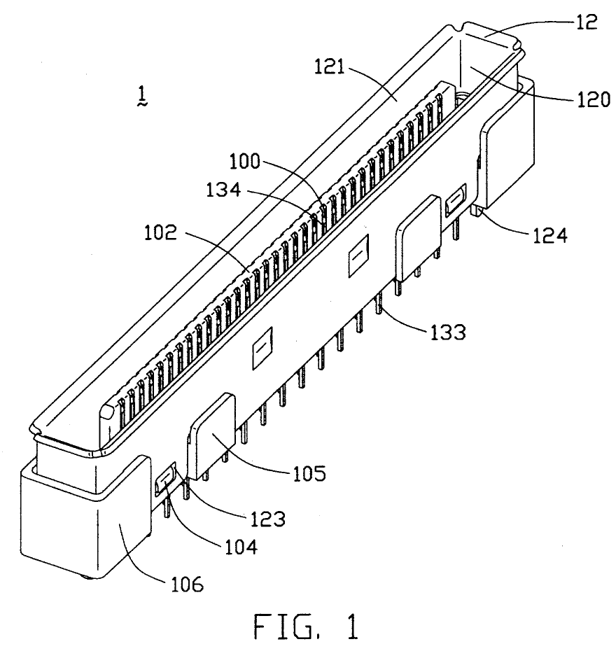

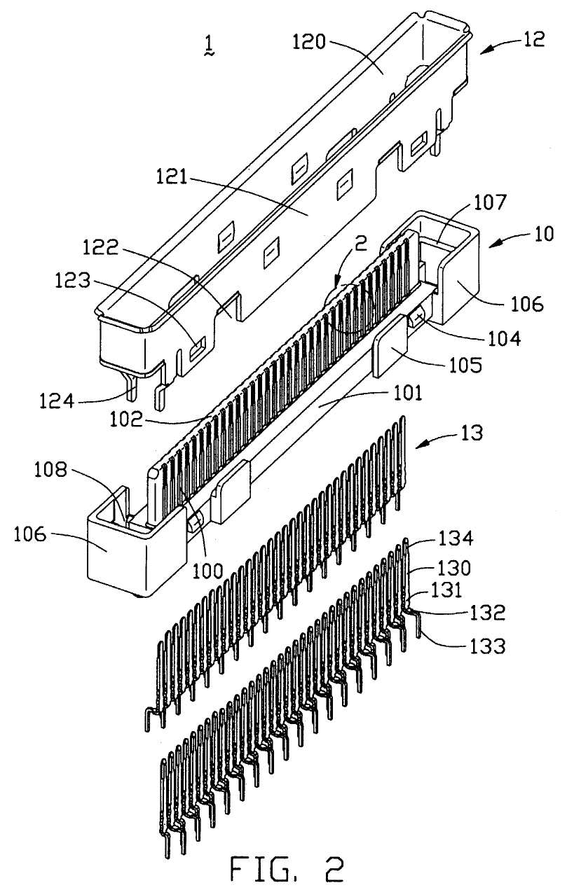

Referring to FIGS. 1-2, an electrical connector 1 for being mated with a complementary connector (not shown) comprises an insulative housing 10, a shielding member 12 and a plurality of terminals 13 received in the insulative housing 10.

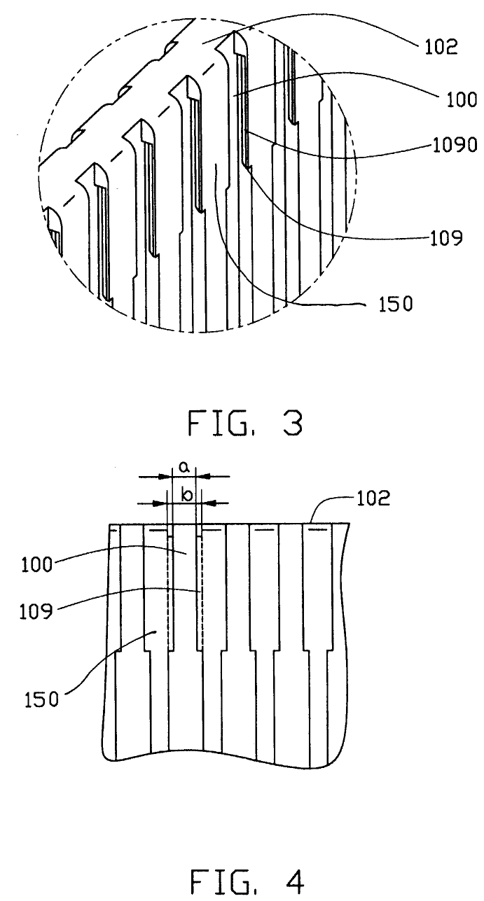

Referring to FIGS. 3-4 in conjunction with FIGS. 1-2, the insulative housing 10 includes a base plate 101, a mating board 102 extending upwardly from a top face of the base plate 101 and a pair of side portions 106 symmetrically formed at two lateral ends of the base plate 101. A plurality of fixing members 105 and a plurality of wedges 104 between the fixing members 105 and the side portions 106 are formed on opposite longitudinal sides of the base plate 101. The mating board 102 has a plurality of passageways 100 defined symmetrically at opposite sides thereof. A pair of tapered portions 109 are formed adjacent to a top end of the mating board 102 and extend from opposite inner walls of each passageway 100 toward each other and into corresponding passageway 100. The tapered portion 109 has a restriction face 1090. A width between outer sides of adjacent opposite tapered portions 109 is “a”, and a width between opposite sides of each passageway 100 is “b” with “b” being larger than “a”. On the other hand, a partition rib 150 is formed between every adjacent two passageways 100, of which a portion adjacent to the top end is enlarged to be in a form of dovetail corresponding to the tapered portions 109 in the passageways 100 by two sides. Each side portion 106 has a flange 107 on an inner wall thereof and a pair of channels 108 adjacent to the flange 107 thereof.

The shielding member 12 has a pair of side walls 121 and a chamber 120 defined between the side walls 121. Each side wall 121 has a pair of mating holes 123 for engaging with corresponding wedges 104 of the base plate 101 and a pair of mating recesses 122 defined adjacent to corresponding mating holes 123 for receiving corresponding fixing members 105 of the base plate 101. Each side wall 121 of the shielding member 12 has a pair of solder tabs 124 extending downwardly therefrom.

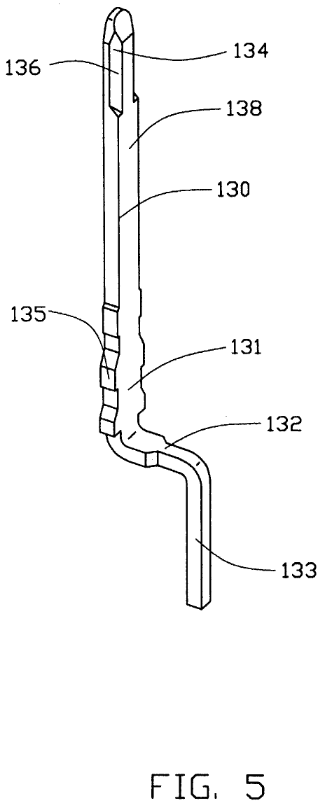

Referring to FIG. 5, each terminal 13 has a mating section 130, a fixing section 131 extending from the mating section 130, a bending section 132 bending substantially perpendicularly to the fixing section 131 and a soldering section 133 extending from the bending section 132 and substantially parallel to the mating section 130. The mating section 130 has a pair of depressed portions 134 recessed from opposite sides adjacent to a top end thereof. The depressed portion 134 has an engaging face 136 depressed from one side of the mating section 130. The mating section 130 has a mating face 138 exposed outside for being mated with a corresponding contact of the complementary connector. The fixing section 131 has a plurality of barbs 135 formed on sides thereof.

In assembly, the shielding member 12 is assembled to the insulative housing 10 with the mating board 102 of the insulative housing 10 extending in the chamber 120 thereof. The wedges 104 and the fixing members 105 of the base plate 101 respectively engage with the mating holes 123 and the mating recesses 122 of the shielding member 12. The soldering tabs 124 extend through corresponding channels 108 of the insulative housing 10 and project downwardly beyond the insulative housing 10.

The mating sections 130 of the terminals 13 extend along corresponding passageways 100 of the insulative housing 10 with the mating face 138 thereof exposed into the chamber 120 and the fixing sections 131 are fixed in the housing 10 with the barbs 135 thereof engaging with inner walls of corresponding passageway 100. The depressed portion 134 engages with the tapered portion 109 of the housing 10 with the engaging face 136 abutting against the restriction face 1090 to prevent the mating section 130 from deflecting outwardly into the chamber 120.

Thus, the terminals 13 are firmly retained within the insulative housing 10 by way of the engagement between the tapered portions 109 and the depressed portions 134 to provide a reliable electrical connection between the connector 1 and the complementary connector.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector, comprising:
an insulative housing comprising a base plate, a mating board extending from the base plate and defining a plurality of passageways, and a tapered portion extending from one side of one passageway; and
a plurality of conductive terminals each comprising a mating section extending along the passageway, a fixing section retained in the passageway, a soldering section, and a depressed portion formed on a corresponding side of the mating section and engaging with said tapered portion.

2. The electrical connector as claimed in claim 1 further comprising a shielding member attached to the housing.

3. The electrical connector as claimed in claim 2, wherein the base plate has a pair of wedges formed on sides thereof, and the shielding member has a pair of elongated side walls having receiving holes engaging with corresponding wedges.

4. The electrical connector as claimed in claim 3, wherein the base plate has a rectangular fixing member, and each elongated side wall of the shielding member has a mating recess receiving corresponding fixing member.

5. The electrical connector as claimed in claim 1, wherein the terminals each comprises a bending section bending substantially perpendicularly to the fixing section, said soldering section extending substantially parallel to the mating section.

6. The electrical connector as claimed in claim 1, wherein the fixing section of the terminal has a plurality of barbs formed on sides thereof for engaging with inner walls of corresponding passageway.

7. The electrical connector as claimed in claim 1, wherein the insulative housing includes another tapered portion extending from another side of the passageway corresponding to the tapered portion.

8. The electrical connector as claimed in claim 7, wherein a width between outer sides of opposite tapered portions is smaller than a width between opposite sides of the passageway.

9. An electrical connector for being mated with a complementary connector, comprising:
an insulative housing comprising a base plate and a mating board extending from the base plate for being mated with a complementary connector, the mating board defining a plurality of passageways in opposite sides thereof and a restriction face extending sidewardly into a corresponding passageway; and
a plurality of conductive terminals each comprising a mating face exposed in a corresponding passageway and an engaging face depressed from one side thereof, said engaging face abutting against the restriction face of the housing.

10. The electrical connector as claimed in claim 9, wherein both the engaging face and the restriction face are slanted.

11. An electrical connector comprising:
an insulative housing defining a mating tongue;
a plurality of passageways defined in said mating tongue;
a partition rib formed between every adjacent two passageways, an enlarged dovetail configuration being formed on the partition rib adjacent to a top end of the mating tongue; and
a plurality of terminals disposed in the corresponding passageways, respectively; wherein
each of said terminals defines a reduced dovetail configuration to comply with the reversely arranged dovetail configurations of the two neighboring partition ribs aside.
